(19) United States
(12) Patent Application Publication
(10) Pub. No.: US 2024/0430567 A1
(43) Pub. Date: Dec. 26, 2024

(54) Depth-Histogram Based Autofocus

(71) Applicant: Google LLC, Mountain View, CA (US)

(72) Inventors: Tongyang Liu; Leung Chun Chan, Sunnyvale, CA (US); Ying Chen Lou, Santa Clara, CA (US); Hsuan Ming Liu, Taipei (TW); Han-Lei Wang, New Taipei City (TW)

(21) Appl. No.: 18/211,947

(22) Filed: Jun. 20, 2023

(51) Int. Cl. H04N 23/67; G06T 7/50

(52) U.S. Cl. CPC H04N 23/672; G06T 7/50; G06T 2207/10028; G06T 2207/20081

(57) ABSTRACT

A method includes receiving a plurality of depth values corresponding to a plurality of areas depicted in an image captured by an image sensor. The method also includes generating a depth histogram categorizing each depth value of the plurality of depth values into a depth value range of a plurality of depth value ranges. The method further includes determining an autofocus distance based on the depth histogram. The method additionally includes causing the image sensor to capture an image based on the autofocus distance.

### BACKGROUND

Many modern computing devices, including mobile phones, personal computers, and tablets, include image capturing devices. Some image capturing devices are configured with telephoto capabilities.

### SUMMARY

In an embodiment, a method includes receiving a plurality of depth values corresponding to a plurality of areas depicted in an image captured by an image sensor. The method also includes generating a depth histogram categorizing each depth value of the plurality of depth values into a depth value range of a plurality of depth value ranges. The method further includes determining an autofocus distance based on the depth histogram. The method additionally includes causing the image sensor to capture an image based on the autofocus distance.

In another embodiment, a computing system includes a control system. The control system is configured to receive a plurality of depth values corresponding to a plurality of areas depicted in an image captured by an image sensor. The control system is also configured to generate a depth histogram categorizing each depth value of the plurality of depth values into a depth value range of a plurality of depth value ranges. The control system is further configured to determine an autofocus distance based on the depth histogram. The control system is also configured to cause the image sensor to capture an image based on the autofocus distance.

In a further embodiment, a non-transitory computer readable medium stores program instructions executable by one or more processors to cause the one or more processors to perform operations. The operations include receiving a plurality of depth values corresponding to a plurality of areas depicted in an image captured by an image sensor. The operations also include generating a depth histogram categorizing each depth value of the plurality of depth values into a depth value range of a plurality of depth value ranges. The operations further include determining an autofocus distance based on the depth histogram. The operations additionally include causing the image sensor to capture an image based on the autofocus distance.

In another embodiment, a system is provided that includes means for receiving a plurality of depth values corresponding to a plurality of areas depicted in an image captured by an image sensor. The system also includes means for generating a depth histogram categorizing each depth value of the plurality of depth values into a depth value range of a plurality of depth value ranges. The system additionally includes means for determining an autofocus distance based on the depth histogram. The system further includes means for causing the image sensor to capture an image based on the autofocus distance.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a diagram illustrating a training phase and an inference phase of one or more trained machine learning models in accordance with example embodiments.

FIG. 4 is a flow chart of a method, in accordance with example embodiments.

FIG. 5 depicts an image, in accordance with example embodiments.

FIG. 6 depicts a depth histogram, in accordance with example embodiments.

FIG. 7 depicts a depth histogram, in accordance with example embodiments.

FIG. 8 depicts an image captured with updated focus settings, in accordance with example embodiments.

FIG. 9 depicts processing blocks for generating a depth histogram, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

An image capturing device may be included in a computing system (e.g., a smartphone, laptop, among other examples). Additionally and/or alternatively, the image capturing device may be a remote image capturing device, which may communicate with a computing system (e.g., a smartphone, laptop, server device, among other examples). Regardless of whether the image capturing device is integrated within the computing system or remote from the computing system, the computing system may display a preview of an image that could be captured by the image capturing device. For instance, if a park is included in the field of view of the image capturing device, the image capturing device may send a preview including the park to the computing system, and the computing system may display the preview including the park as included in the field of view of the image capturing device.

An issue that may arise in this process is capturing or showing a preview of an image that is properly focused. In particular, advanced autofocus processes may cause a delay in capturing an image, due to the processing time and computing power necessary for the autofocus processes. For instance, a computing system may determine one or more regions of interest as part of executing the autofocus processes, and determining these regions of interest may cause the autofocus processes to take more time and/or computing power.

Described herein are techniques for adjusting autofocus settings that may be used without determining a region of interest. In particular, the computing system may determine a depth histogram based on depth values. The computing system may determine one or more peaks in the depth histogram, and based on the identified peaks, the computing system may determine an autofocus distance and/or focus settings. The computing system may then cause an image sensor to capture an image based on the autofocus distance and/or focus settings.

The computing system may receive depth values from a sensor, such as a phase detection sensor. The depth values may represent a distance from the sensor to an area in the environment. For instance, if the sensor is pointed to an area including a desk in front of a wall, the depth values may include a distance from the sensor to the desk and to the wall. In some examples, each pixel of an image may have an associated depth value representing a distance or a relative distance from the sensor (perhaps an image sensor) to the object depicted by the image (e.g., a plant, a wall, a desk, etc.).

Each depth value may have an associated confidence value, which the computing system may use to determine if the depth value may be used in the determination of focus settings. The computing system may compare each confidence value to a threshold confidence value. If the confidence value associated with a particular depth value is less than the threshold confidence value, then the computing system may remove the particular depth value from the depth values being used in the determination of focus settings. Whereas, if the confidence value associated with a particular depth value is greater than the threshold confidence value, then the computing system may use the particular depth value in the determination of focus settings. In some examples, the computing system may use one or more threshold confidence values in verifying depth values, where each threshold confidence value is associated with a particular classification of an area in an image.

The computing system may categorize the depth values into various depth value ranges to determine a depth histogram. The computing system may determine depth value ranges based on a minimum and maximum of the depth values, perhaps evenly splitting the range of depth values from the minimum and maximum of depth values into a plurality of depth value ranges. For instance, if the minimum of the depth values is 1 meter and the maximum of the depth values is 10 meters, then the computing system may determine the plurality of depth value ranges as 1 meter to 2 meters, 2 meters to 3 meters, 3 meters to 4 meters, and so on.

In some examples, the computing system may determine depth value ranges based on a count of depth values. The computing system may determine more depth value ranges when the computing system receives more depth values. For instance, the computing system may determine ten depth value ranges when the computing system receives 100 depth values, but the computing system may determine 25 depth value ranges when the computing system receives 500 depth values.

The computing system may categorize the depth values into depth value ranges, such that a depth histogram is plotted with counts of depth values versus the depth value ranges. For instance, a depth value of 5.5 meters may be categorized in a depth value range of 5 meters to 6 meters. The computing system may repeat this for each depth value of the received depth values. The computing system may determine the depth histogram based on the number of depth values in each depth value range, plotting the counts of depth values versus the depth value ranges.

The computing system may determine one or more peaks in the depth histogram, and the computing system may select a depth range on which to base the focus settings. The peaks in the depth histogram may be local maximas of the depth histogram. The computing system may select a peak based on the peak being associated with a depth value range representing areas closest to the sensor among other factors. The computing system may then determine focus settings based on the depth value range.

The autofocus method described herein may be a histogram-based approach, which may take less time and processing power than other autofocus processes. For example, autofocus processes involving identifying regions of interest may involve using a machine learning model or other computationally intensive algorithms to identify regions within an image from which a computing system may then identify regions of interest. In contrast, the autofocus process described herein involves categorizing depth values, counting depth values in each category, comparing a count of depth values in each category, and selecting a depth value or autofocus distance on which to base the autofocus settings. This computationally simple process may thus take less time and processing power than other autofocus processes. In some examples, a computing system may use the autofocus method described in conjunction with other autofocus processes, perhaps to accommodate delays in the other autofocus processes.

### II. EXAMPLE SYSTEMS AND METHODS

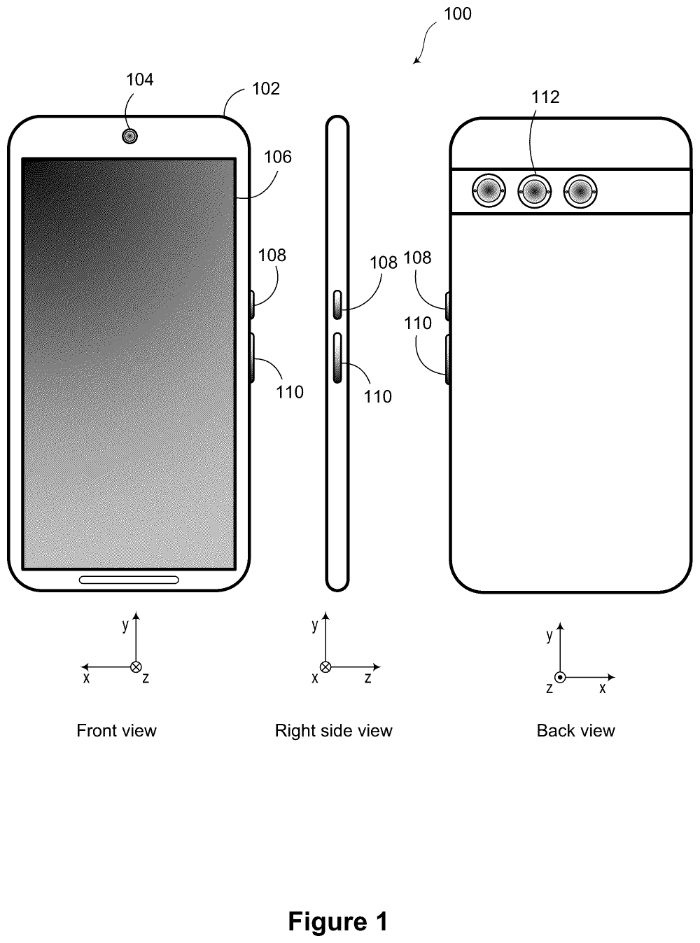

FIG. 1 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

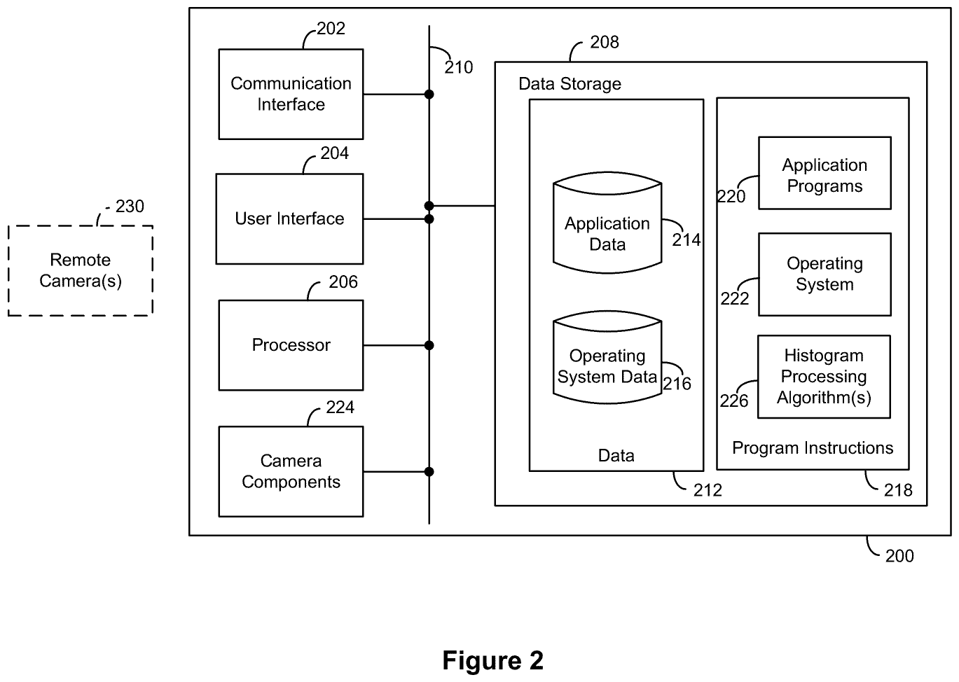

FIG. 2 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

Histogram processing algorithm(s) 226 may include one or more stored algorithms programmed to process histogram information to facilitate autofocus as described herein. In some examples, histogram processing algorithm(s) 226 may include one or more trained machine learning models. In other examples, histogram processing algorithm(s) 226 may be based on heuristics without the use of machine learning. In further examples, a combination of different types of histogram processing algorithm(s) 226 may be used as well.

In further examples, one or more remote cameras 230 may be controlled by computing system 200. For instance, computing system 200 may transmit control signals to the one or more remote cameras 230 through a wireless or wired connection. Such signals may be transmitted as part of an ambient computing environment. In such examples, inputs received at the computing system 200 (for instance, physical movements of a wearable device) may be mapped to movements or other functions of the one or more remote cameras 230. Images captured by the one or more remote cameras 230 may be transmitted to the computing system 200 for further processing. Such images may be treated as images captured by cameras physically located on the computing system 200.

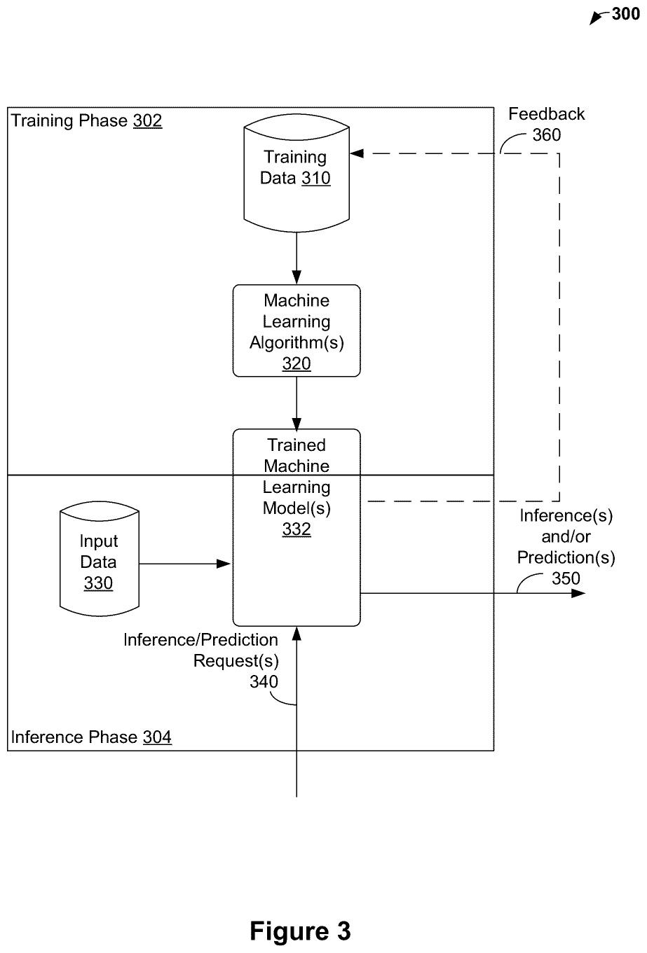

FIG. 3 shows diagram 300 illustrating a training phase 302 and an inference phase 304 of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Producing trained machine learning model(s) 332 during training phase 302 may involve determining one or more hyperparameters, such as one or more stride values for one or more layers of a machine learning model as described herein. Then, during inference phase 304, trained machine learning model 332 can receive input data 330 and one or more inference/prediction requests 340 (perhaps as part of input data 330) and responsively provide as an output one or more inferences and/or predictions 350. The one or more inferences and/or predictions 350 may be based in part on one or more learned hyperparameters, such as one or more learned stride values for one or more layers of a machine learning model as described herein

As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results.

Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310. This further training of the machine learning algorithm(s) 320 and/or the pre-trained machine learning model using training data 310 of CD1's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

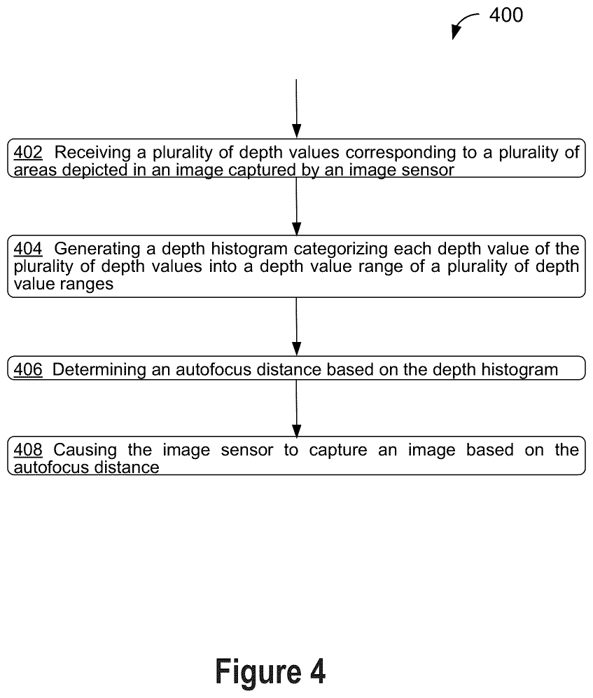

FIG. 4 is a flow chart of method 400, in accordance with example embodiments. Method 400 may be executed by one or more computing systems (e.g., computing system 200 of FIG. 2) and/or one or more processors (e.g., processor 206 of FIG. 2). Method 400 may be carried out on a computing system, such as computing system 100 of FIG. 1.

At block 402, method 400 includes receiving a plurality of depth values corresponding to a plurality of areas depicted in an image captured by an image sensor. In some examples, a computing system may receive data from one or more sensors on the computing system or from sensors remote from the computing system. The data may include depth values, each of which may correspond to a representation of the distance from the one or more sensors to an area in the environment. The computing system may receive sensor data representative of an environment that an image sensor is attempting to capture.

In some examples, receiving the sensor data or otherwise requesting the sensor data may be based on the computing system receiving an indication of an application starting use of the image sensor. Because the autofocus method described herein may not be based on identifying regions of interest and/or focusing on particular regions of interest, the computing system may be able to quickly determine an autofocus distance and/or other focus settings. The speed at which the computing system may be able to carry out the autofocus process described herein may thus help facilitate an initial autofocused image and/or initial focus settings, which may be further adjusted based on other autofocus processes.

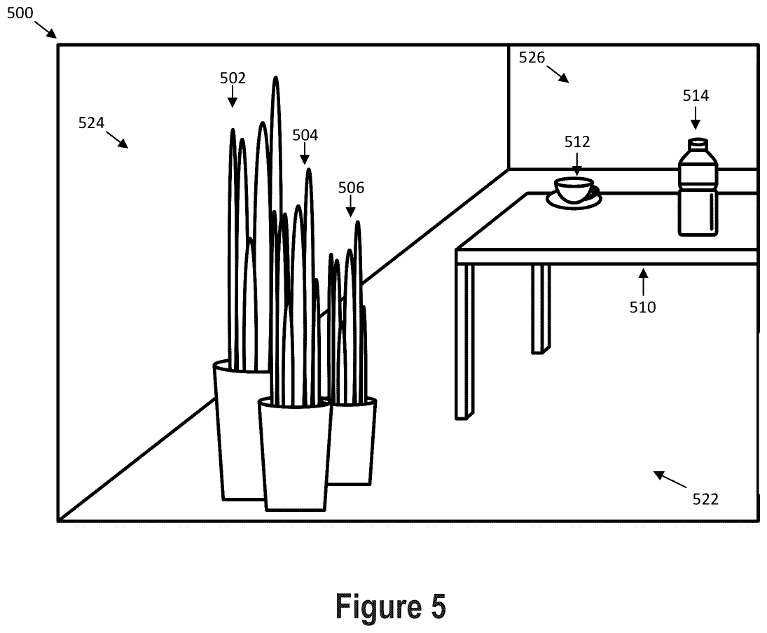

Rather than identify regions of interest, the computing system may use the depth values as a basis for determining an autofocus distance and/or other focus settings, which may help an image capturing device or a lens of the image capturing device focus. For example, FIG. 5 depicts image 500, in accordance with example embodiments. Image 500 may include various objects in an environment, including wall 524, wall 526, plant 502, plant 504, plant 506, floor 522, table 510, cup 512, and water bottle 514. The computing system may receive sensor data corresponding to the environment depicted in image 500, and the sensor data may include depth values that correspond to how far the object is from the image sensor or other sensor capturing the environment.

In some examples, the computing system may use a dual pixel sensor to collect data. The computing system may use the data collected by the dual sensor data to calculate disparity values. In particular, the dual sensor data may include left and right data for each pixel, and the computing system may compute the disparity between the left and right data for each pixel to obtain the disparity values. These disparity values may correspond to the depth values.

Further, the computing system may receive or determine confidence values for each depth value, and the computing system may use the confidence values as a basis to verify the depth values. In particular, the computing system may determine whether each confidence value is greater than a threshold confidence value. If the confidence value is greater than the threshold confidence value, the computing system may use the corresponding depth values in determining focus settings. If the confidence value is not greater than the threshold confidence value (e.g., lesser than the threshold confidence value), the computing system may exclude the corresponding depth values to be used in determining focus settings.

In some examples, the computing system may determine classifications for various areas of the environment and/or image, and the computing system may verify the depth values based on the classification of the respective area of the image. The computing system may apply a segmentation model, a machine learning model, and/or other classification algorithm to an image or other sensor data of the environment to determine a classification for various areas in the image and/or environment. Each classification may be associated with a particular threshold confidence value, and the depth values may be associated with a particular area of the environment and/or of the image. The computing system may compare the confidence value associated with the depth value with the particular threshold confidence value associated with the region of the depth value to verify the depth value.

Using confidence values associated with various regions of the image may help facilitate accurate determination of focus settings. For instance, an area associated with being a wall (e.g., wall 524, 524) may have a lesser confidence threshold level than objects in the environment (e.g., cup 512, bottle 514, and table 510). By allowing depth values associated with lesser confidence values, the computing system may allow for a maximum number of depth values to be included, which may allow for more depth values on which to base a determination of focus settings.

Further, using threshold confidence values to verify depth values may help facilitate a quick autofocus method. Using more complicated algorithms to verify depth values or otherwise determine focus settings may result in delays in a determination of focus settings, which could result in certain objects not being captured. A simple comparison between confidence values associated with depth values and threshold confidence values may take less time and processing power than more complicated autofocus processes, allowing for the autofocus to be quick and for the computing system to more quickly capture an image of the environment. Capturing an environment quickly may be especially important with a changing environment.

Referring back to FIG. 4, at block 404, method 400 includes generating a depth histogram categorizing each depth value of the plurality of depth values into a depth value range of a plurality of depth value ranges.

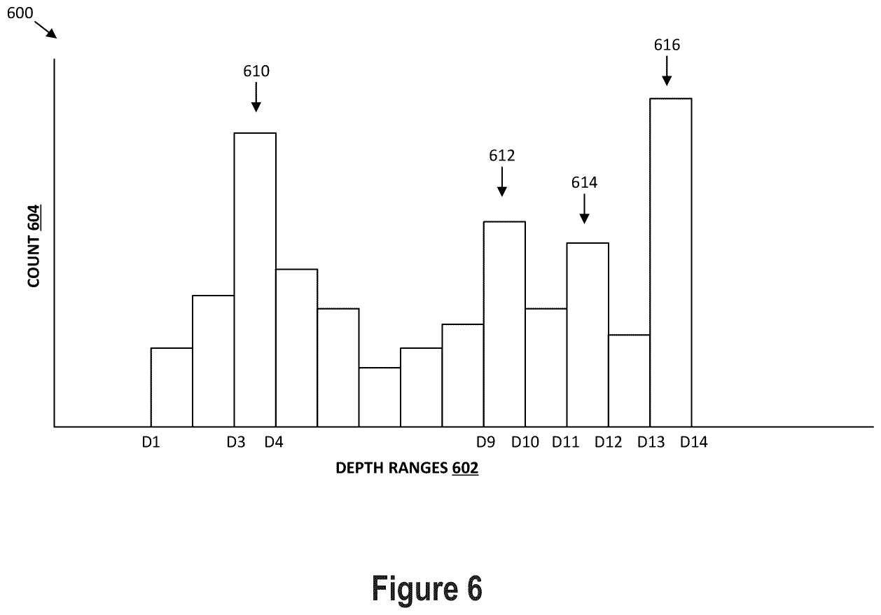

FIG. 6 depicts depth histogram 600, in accordance with example embodiments. The computing system may determine depth histogram 600 based on depth values associated with image 500. In particular, the computing system may determine a minimum and a maximum of the depth values for a depth value range and divide the depth value range into a plurality of depth value ranges. For instance, the computing system may determine a minimum depth value of D1 and a maximum depth value of D14. The computing system may evenly divide up the depth value range from D1 to D14 to obtain depth value ranges 602. Additionally and/or alternatively, the computing system may use a predetermined depth value range 602.

In some examples, the computing system may determine depth value ranges 602 based on a count of how many depth values are to be included in the depth histogram. The computing system may determine more depth value ranges 602 when more depth values are included. Whereas, the computing system may reduce the number of depth value ranges 602 when less depth values are included. Having an adjustable number of depth value ranges may help facilitate determination of focus settings, by allowing for the distribution of depth values to be more clearly defined. If, for instance, the number of depth value ranges roughly equalled the number of depth values being included in the depth histogram, the computing system may be unable to determine a clear distribution of depth values, as each depth value range may include only a few, if any, depth values.

The computing system may categorize each depth value into one or more depth value ranges, and the depth histogram may plot a count of the depth values associated with each depth value range against the depth value ranges. For instance, a depth value with a value between D3 and D4 may be associated with the depth value range of D3 and D4. The computing system may determine a count of the number of depth values within the depth value range D3 and D4, and the computing system may plot the count as depth value range bar 610. When the computing system categorizes various depth values under various depth value ranges, a distribution such as the one shown in depth histogram 600 may be obtained.

As such, depth value range D3 to D4 of depth value range bar 610 may primarily include depth values associated with plants 502, and 506 of FIG. 5. Depth value range bar 612 associated with a depth value range of D9 to D10 may primarily include depth values associated with table 510 and bottle 514. Depth value range bar 614 associated with a depth value range of D11 to D12 may primarily include depth values associated with table 510 and cup 512. Further, depth value range bar 616 associated with a depth value range of D13 to D14 may primarily include depth values associated with wall 526.

Referring back to FIG. 4, at block 406, method 400 includes determining an autofocus distance based on the depth histogram.

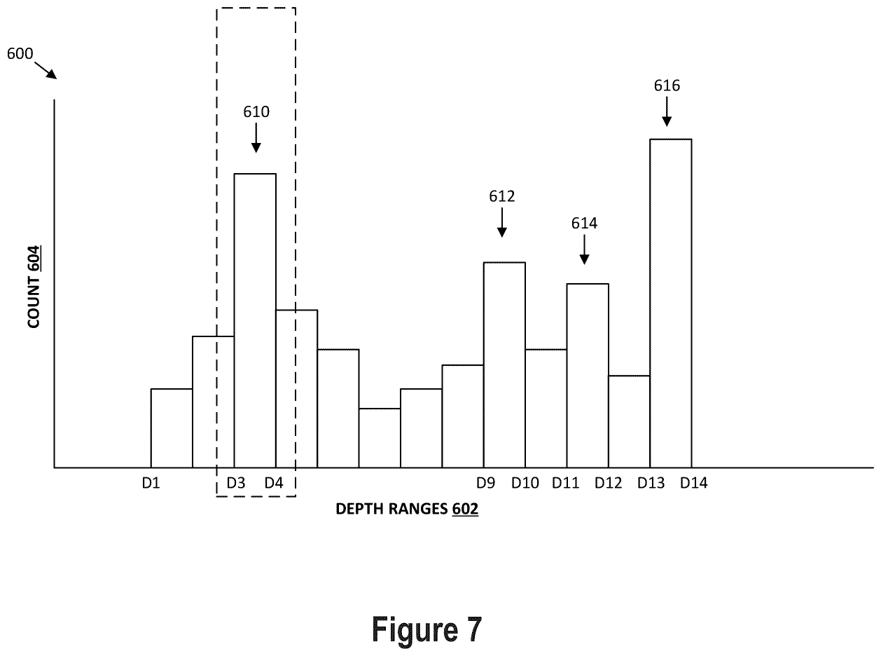

FIG. 7 depicts a depth histogram, in accordance with example embodiments. As depicted in FIG. 7, the computing system may select a depth range (e.g., depth range 610) from which to determine an autofocus distance or otherwise determine focus settings. The computing system may select a depth range based on identifying peaks in depth histogram 600, among other examples.

In particular, the computing system may determine peaks in depth histogram (e.g., depth histogram 600), and the computing system may select the peak associated with a minimum range of depth values. For instance, the computing system may determine that histogram 600 includes peaks at depth value range bar 610, depth value range bar 612, depth value range bar 614, and depth value range bar 616. The computing system may compare the associated depth values of depth value range bars 610, 612, 614, and 616 (e.g., the computing system may compare depth value range D3 to D4 of depth value range bar 610 with depth value range D9 to D10 of depth value range bar 612, and so on). The computing system may determine that the depth range D3 to D4 associated with depth value range bar 610 is the least in value (e.g., the closest to the image sensor) out of all depth value ranges associated with the identified peaks (e.g., depth value range bar 610, depth value range bar 612, depth value range bar 614, and depth value range bar 616). The computing system may then use depth value range D3 to D4 to determine focus settings. By using the minimum depth value range, the computing system may be able to focus on an area most likely to include a region of interest without actually identifying a region of interest.

Additionally and/or alternatively, the computing system may determine an autofocus distance or focus settings based on selecting a peak with a maximum peak height. For instance, the computing system may determine peaks of depth value range bars 610, 612, 614, and 616 in depth histogram 600. The computing system may determine a peak height associated with each of depth value range bars 610, 612, 614, and 616 (e.g., a count of depth values associated with each depth value range bar), and the computing system may compare the peak heights to determine a maximum height.

The computing system may determine a depth value as an autofocus distance or otherwise for determining focus settings based on the selecting a depth value from the selected depth value range. For instance, the computing system may determine the depth value range of D3 and D4 as the selected depth value range, perhaps based on depth value range bar 610 having the depth value range with depth values representing an area closest to the image sensor. The computing system may determine a depth value as an autofocus distance or otherwise to be used in determining focus settings based on determining an average depth value of depth value range bar 610 or a median depth value of depth value range bar 610. The computing system may also determine the depth value as a depth value in the middle of depth value range D3 and D4. In some examples, the computing system may use a combination of these factors to determine a depth value to be used in determining focus settings.

The computing system may use the determined depth value to determine autofocus distance and/or focus settings based on the depth value.

Additionally and/or alternatively, the computing system may apply a machine learning model to depth histogram 600 to determine a peak or a depth value of depth histogram 600 on which to base a determination of autofocus distance or to determine an autofocus distance or focus settings. In particular, the computing system may train the machine learning model on a dataset including depth histograms and focused images. The computing system may then use the trained machine learning model to determine a peak or a depth value of depth histogram 600 on which to base a determination of autofocus distance or to determine an autofocus distance or focus settings.

Referring back to FIG. 4, at block 408, method 400 includes causing the image sensor to capture an image based on the autofocus distance.

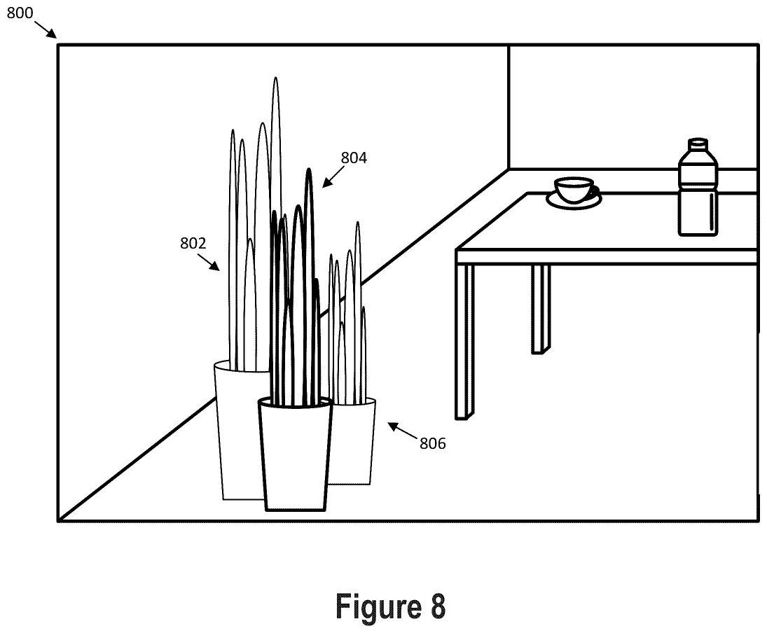

FIG. 8 depicts image 800 captured with updated focus settings, in accordance with example embodiments. As shown in image 800, plants 802 and 806 may be in focus, whereas plant 804 and other objects depicted in image 800 may not be in focus. As mentioned above, the focus settings may be based on a depth histogram (e.g., depth histogram 600 of FIGS. 6 and 7), rather than a region of interest, which may allow for more efficient adjustment of focus settings.

In some examples, the image sensor may include a lens, and the computing system may adjust a focus setting of the lens based on the determined autofocus distance. In particular, the computing system may send an indication to the lens to adjust the focal point of the lens to the distance indicated by the autofocus distance.

After causing the image sensor to capture the image based on the autofocus distance, the computing system may execute a further autofocus process to determine a refined autofocus distance or otherwise determine refined focus settings. The further autofocus process may use more computing power and/or more processing time than the autofocus method described herein.

In some examples, causing the image sensor to capture an image based on the autofocus distance comprises adjusting a focus setting of an image sensor based on the autofocus distance, wherein the image sensor comprises a lens.

Referring back to FIG. 4, in some examples, method 400 further comprises, after causing the image sensor to capture the image based on the autofocus distance, executing a further autofocus process to determine a refined autofocus distance, wherein generating the depth histogram and determining the autofocus distance is associated with a first average execution duration, wherein executing the further autofocus process to determine the refined autofocus distance is associated with a second average execution duration, wherein the first average execution duration is less than the second average execution duration.

In some examples, method 400 further comprises, after causing the image sensor to capture the image based on the autofocus distance, executing a further autofocus process to determine a refined autofocus distance, wherein generating the depth histogram and determining the autofocus distance is associated with a first average processing power, wherein executing the further autofocus process to determine the refined autofocus distance is associated with a second average processing power, wherein the first average processing power is less than the second average processing power.

In some examples, the method is executed based on receiving an indication of an application starting use of the image sensor.

In some examples, determining the autofocus distance based on the depth histogram comprises (i) determining one or more peaks of the depth histogram, wherein each of the one or more peaks is associated with a range of depth values, (ii) selecting a peak from the one or more peaks, wherein the selected peak is associated with a minimum range of depth values of the one or more peaks, and (iii) determining the autofocus distance based on the selected peak.

In some examples, determining the autofocus distance based on the depth histogram comprises (i) determining one or more peaks of the depth histogram, wherein each peak is associated with a peak height, (ii) selecting a peak from the one or more peaks based on the selected peak being associated with a maximum peak height of the one or more peaks, and (iii) determining the autofocus distance based on the selected peak.

In some examples, determining the autofocus distance based on the depth histogram is based on applying a machine learning model to the depth histogram.

In some examples, determining the autofocus distance based on the depth histogram is not based on one or more regions of interest associated with the image captured by the image sensor.

In some examples, generating the depth histogram comprises (i) determining a range of depth values of the plurality of depth values, (ii) based at least on the range of depth values, determining the plurality of depth value ranges to evenly divide the range of depth values, and (iii) determining the depth histogram based on the plurality of depth value ranges.

In some examples, generating the depth histogram comprises determining a count of the plurality of depth values, and, based at least on the count of the plurality of depth values, determining the plurality of depth value ranges, wherein the depth histogram is determined based on the plurality of depth value ranges.

In some examples, receiving the plurality of depth values corresponding to the plurality of areas depicted in the image is based on receiving data collected from a dual pixel sensor.

In some examples, the plurality of depth values are a plurality of disparity values determined based on the data collected from the dual pixel sensor.

In some examples, each depth value of the plurality of depth values is associated with a confidence value, wherein method 400 further comprises verifying that the confidence value associated with each depth value of the plurality of depth values is greater than a threshold confidence value.

In some examples, method 400 further comprises removing each depth value with an associated confidence value less than the threshold confidence value from the plurality of depth values.

In some examples, each depth value of the plurality of depth values is associated with a confidence value and a classification of an area represented by the depth value, wherein method 400 further comprises verifying that the depth value associated with each depth value of the plurality of depth values is greater than a threshold confidence value associated with the classification of the area represented by the depth value.

In some examples, determining the autofocus distance based on the depth histogram comprises selecting a depth value range from the plurality of depth value ranges, determining an average depth value based on the selected depth value range, and determining the autofocus distance based on the average depth value.

In some examples, a computing system includes a control system configured to perform operations comprising those of method 400 and those described above.

In some examples, the control system is further configured to determine the plurality of depth values based on data collected from a phase detection sensor.

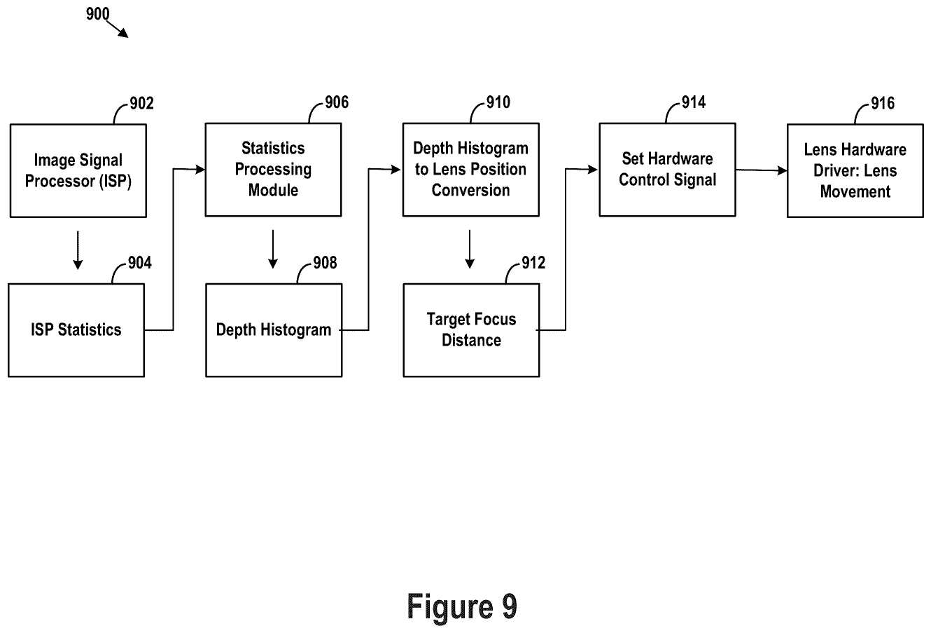

In some examples, a non-transitory computer readable medium storing program instructions executable by one or more processors to cause the one or more processors to perform operations comprising those of method 300 and those described above. As described herein, the autofocus system may be an open loop system that is not based on regions of interest. The input for the autofocus system includes depth information from a captured image. More specifically, in some examples, an image signal processor (ISP) 902 may generate ISP statistics 904. The ISP 902 may include one or more software and/or hardware modules, with each module handling a different task in an imaging pipeline. ISP statistics 904 may include phase difference information from which depth values can be generated for an image. The statistics processing module 906 may convert the ISP statistics 904 into a depth histogram 908. The statistics processing module 906 may consider confidence values associated with depth values in generating the depth histogram 908 as described previously. In other examples, depth histogram 908 may be generated based on depth values associated with a captured image based on other processing blocks than those illustrated in FIG. 9.

Once generated, the depth histogram 908 may then be processed by an autofocus algorithm to autofocus an imaging sensor. First, depth histogram 908 may be processed by module 910 which converts the depth histogram 908 into a target focus distance 912. As previously described, this conversion may be based on one or more heuristic or machine learned processes. Subsequently, the target focus distance 912 may be sent to the autofocus algorithm's hardware controller 914 to finalize a target lens position. Finally, the target lens position may be output from the hardware controller 914 to the hardware driver 916 to control a lens of the imaging sensor to move to the target lens position to autofocus the imaging sensor based on target focus distance 912 to complete the autofocus process.

### III. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
receiving a plurality of depth values corresponding to a plurality of areas depicted in an image captured by an image sensor;
generating a depth histogram categorizing each depth value of the plurality of depth values into a depth value range of a plurality of depth value ranges;
determining an autofocus distance based on the depth histogram; and
causing the image sensor to capture an image based on the autofocus distance.

2. The method of claim 1, wherein causing the image sensor to capture the image based on the autofocus distance comprises:
adjusting a focus setting of the image sensor based on the autofocus distance, wherein the image sensor comprises a lens.

3. The method of claim 1, wherein the method further comprises:
after causing the image sensor to capture the image based on the autofocus distance, executing a further autofocus process to determine a refined autofocus distance, wherein generating the depth histogram and determining the autofocus distance are associated with a first average execution duration, wherein executing the further autofocus process to determine the refined autofocus distance is associated with a second average execution duration, wherein the first average execution duration is less than the second average execution duration.

4. The method of claim 1, wherein the method further comprises:
after causing the image sensor to capture the image based on the autofocus distance, executing a further autofocus process to determine a refined autofocus distance, wherein generating the depth histogram and determining the autofocus distance are associated with a first average processing power, wherein executing the further autofocus process to determine the refined autofocus distance is associated with a second average processing power, wherein the first average processing power is less than the second average processing power.

5. The method of claim 1, wherein the method is executed based on receiving an indication of an application starting use of the image sensor.

6. The method of claim 1, wherein determining the autofocus distance based on the depth histogram comprises:
determining one or more peaks of the depth histogram, wherein each of the one or more peaks is associated with a range of depth values;
selecting a peak from the one or more peaks, wherein the selected peak is associated with a minimum range of depth values of the one or more peaks; and
determining the autofocus distance based on the selected peak.

7. The method of claim 1, wherein determining the autofocus distance based on the depth histogram comprises:
determining one or more peaks of the depth histogram, wherein each peak is associated with a peak height;
selecting a peak from the one or more peaks based on the selected peak being associated with a maximum peak height of the one or more peaks; and
determining the autofocus distance based on the selected peak.

8. The method of claim 1, wherein determining the autofocus distance based on the depth histogram is based on applying a machine learning model to the depth histogram.

9. The method of claim 1, wherein determining the autofocus distance based on the depth histogram is not based on one or more regions of interest associated with the image captured by the image sensor.

10. The method of claim 1, wherein generating the depth histogram comprises:
determining a range of depth values of the plurality of depth values;
based at least on the range of depth values, determining the plurality of depth value ranges to evenly divide the range of depth values; and
determining the depth histogram based on the plurality of depth value ranges.

11. The method of claim 1, wherein generating the depth histogram comprises:
determining a count of the plurality of depth values;
based at least on the count of the plurality of depth values, determining the plurality of depth value ranges, wherein the depth histogram is determined based on the plurality of depth value ranges.

12. The method of claim 1, wherein receiving the plurality of depth values corresponding to the plurality of areas depicted in the image is based on receiving data collected from a dual pixel sensor.

13. The method of claim 12, wherein the plurality of depth values are a plurality of disparity values determined based on the data collected from the dual pixel sensor.

14. The method of claim 1, wherein each depth value of the plurality of depth values is associated with a confidence value, wherein the method further comprises:
verifying that the confidence value associated with each depth value of the plurality of depth values is greater than a threshold confidence value.

15. The method of claim 14, further comprising:
removing each depth value with an associated confidence value less than the threshold confidence value from the plurality of depth values.

16. The method of claim 1, wherein each depth value of the plurality of depth values is associated with a confidence value and a classification of an area represented by the depth value, wherein the method further comprises:
verifying that the depth value associated with each depth value of the plurality of depth values is greater than a threshold confidence value associated with the classification of the area represented by the depth value.

17. The method of claim 1, wherein determining the autofocus distance based on the depth histogram comprises:
selecting a depth value range from the plurality of depth value ranges;
determining an average depth value based on the selected depth value range; and
determining the autofocus distance based on the average depth value.

18. A computing system comprising:
a control system configured to:
receive a plurality of depth values corresponding to a plurality of areas depicted in an image captured by an image sensor;
generate a depth histogram categorizing each depth value of the plurality of depth values into a depth value range of a plurality of depth value ranges;
determine an autofocus distance based on the depth histogram; and
causing the image sensor to capture an image based on the autofocus distance.

19. The computing system of claim 18, wherein the control system is further configured to determine the plurality of depth values based on data collected from a phase detection sensor.

20. A non-transitory computer readable medium storing program instructions executable by one or more processors to cause the one or more processors to perform operations comprising:
receiving a plurality of depth values corresponding to a plurality of areas depicted in an image captured by an image sensor;
generating a depth histogram categorizing each depth value of the plurality of depth values into a depth value range of a plurality of depth value ranges;
determining an autofocus distance based on the depth histogram; and
causing the image sensor to capture an image based on the autofocus distance.
